(19) United States
(12) Patent Application Publication
(10) Pub. No.: US 2019/0031075 A1
(43) Pub. Date: Jan. 31, 2019

(54) Autonomous Delivery Platform

(71) Applicant: Koch, Culver City, CA (US)

(72) Inventor: David Christian Koch, Culver City, CA (US)

(73) Assignee: Koch, Culver City, CA (US)

(21) Appl. No.: 15/662,306

(22) Filed: Jul. 28, 2017

(51) Int. Cl. B60P 1/64; G06Q 50/28; G05B 19/418; G05D 1/02; B25J 9/16

(52) U.S. Cl. CPC B60P 1/6481; G06Q 50/28; G05D 2201/0213; G05D 1/0225; B25J 9/162; G05B 19/41895

(57) ABSTRACT

A package delivery platform which attaches to an autonomous vehicle comprising, a module containing controls and a manipulator arm with a hand capable of grasping a package and placing it in an enclosure at a delivery location, detachable container with a securable lid in which packages are carried, and a receptacle with an automated, securable lid which mounts near the roadway at a delivery location for receiving packages.

### CROSS-REFERENCE TO RELATED DOCUMENTS

The present application claims priority to provisional patent application No. 62/494,150, filed on Jul. 28, 2016, disclosures of which are incorporated herein at least by reference. p

### FIELD OF INVENTION

The present invention relates to advances in autonomous vehicle technology and autonomous package delivery systems. The present invention also relates to software applications that allow independently operated vehicles participate in a highly efficient network to carry passengers from point to point.

### BACKGROUND

As supply chains have become increasingly efficient over the last several decades, the last mile of the chain has remained largely the same; it is the most expensive and slowest part. Recent proposals for last mile delivery have made use of self driving vehicles to carry goods to their final destination. All of these proposals have one significant shortcoming: without a driver to bring the package to your doorstep, the recipient has to collect the package. This limits delivery times to hours when the recipient is at home. Solving the technical challenge of moving the package from the vehicle to a secure place at the delivery location will close a significant gap in the supply chain. The present invention proposes using a robotic arm to pick packages from a box mounted to the vehicle and drop them into a securable “mailbox” at the delivery location. The arm and box would be separate modules that would attach to the car with a socket similar to a trailer hitch. This allows passenger carrying self driving cars to be converted to package delivery vehicles during off peak hours.

The present invention would not only replace traditional parcel delivery but could unlock new markets. Point to point local delivery, which until now lacked the efficiency of centralized hub and spoke delivery models could be made competitive. The inventory of local brick and mortar stores could be made available to customers within a small radius. The short delivery times made possible by this model would allow perishable goods to arrive at your door in much the same way that the milkman once delivered milk. Grocery stores could load containers at night for pickup and delivery to customers in the morning. This system could also replace courier services, making on demand point to point trips in much the same way that uber does. This system has the potential to revitalize local commerce, linking customers to a vast network of businesses that are nearby. It would blur the distinction between brick and mortar and Ecommerce, enabling local stores to serve walk in customers and online customers.

### BRIEF SUMMARY OF INVENTION

The present invention comprises a securable enclosure in which packages are carried, a robotic arm unit with battery and controls, and a compartment which is permanently mounted at the delivery location. The robotic arm module is attached to the vehicle using a socket similar to a trailer hitch. The enclosure is then mounted to the arm module autonomously. The autonomous vehicle drives to the delivery location, the enclosure lid is opened, a package is then removed using the arm and placed in the enclosure mounted at the location.

Packages are positioned in the enclosure in manner that allows each package to be accessible to the robotic arm. Each package is sorted at the loading location according to size. Packages are then mounted to a flat panel that most closely matches its width and height. Panels are produced in a number of discrete sizes to accommodate the range of package sizes. The enclosure interior is divided into a number of compartments of different sizes to match the panel sizes. The sides of the compartments are grooved to accept the panels. The packages mounted to the panels are slid into the grooves such that the previous package is given clearance. In this way the enclosure can be packed with a number of packages of varying sizes in a manner that uses the given volume efficiently. Each package is indexed according to the slot it is placed in such that it can be retrieved easily without moving aside other packages.

The delivery enclosure would be fitted with retractable legs that would allow it to stand unassisted at the correct height to be coupled with the delivery vehicle and arm module. Enclosures could be deposited at a location and picked up by a vehicle already fitted with the robotic arm module. Likewise, empty delivery enclosures could be exchanged for loaded ones at a remote location without loading facilities. A number of delivery enclosures could be loaded onto a larger vehicle for transport to and from pick-up locations. A large number of preloaded enclosures could be shipped by truck from an origin point such as a factory or warehouse to a location close to the final delivery location.

The robotic arm is fitted with a grasping hand that grips the panel and lifts it along with the attached package out of the enclosure. The arm then carries that package to enclosure mounted at the delivery location and deposits it there.

The enclosure at the delivery location has a locking lid that is opened by a radio or infrared signal from the approaching vehicle. The enclosure can be fitted with an interior with slots similar to the delivery enclosure. This allows packages placed in the enclosure to be picked up by the delivery vehicle and delivered to another location.

A system is also proposed whereby packages could be autonomously loaded and unloaded into delivery enclosures at a central distribution facility. Packages could be placed into enclosures to optimise local delivery. This arrangement would minimize the need for centralized sorting facilities and thereby make transport of goods more efficient and timely.

Another embodiment of the invention allows packages to be placed into the trunk of unattended vehicles. A parked vehicle that is equipped with a remotely operated trunk release is used as a secure drop-off point for a package.

Another embodiment of the invention allows package delivery to a cluster of shared mailboxes located in areas where individual mailboxes would be impractical. Each mailbox in the cluster would be individually securable and could be unlocked using a unique access code provided to the package recipient. This access code could be either a numeric code entered manually by the recipient or an electronic code transmitted from a device carried by the recipient directly to a reading unit in the mailbox.

### BRIEF DESCRIPTION OF DRAWINGS

Having thus described the invention in general terms, reference will now be made to the accompanying drawings, which are not necessarily drawn to scale, and wherein:

FIG. 1. illustrates the invention in perspective view with enclosure lid open and arm extended.

FIG. 2. illustrates the invention in perspective view making a delivery at a typical detached dwelling.

FIG. 3. illustrates the invention in perspective view with the major components separated for clarity.

FIG. 4. illustrates the invention in perspective view with the arm module attached to the vehicle and the carrying container ready for attachment.

FIG. 5. illustrates the invention in perspective view making a delivery to a cluster of enclosures in a typical urban location.

FIG. 6. illustrates the invention in top view with the container lid open and the manipulator arm extended holding a package.

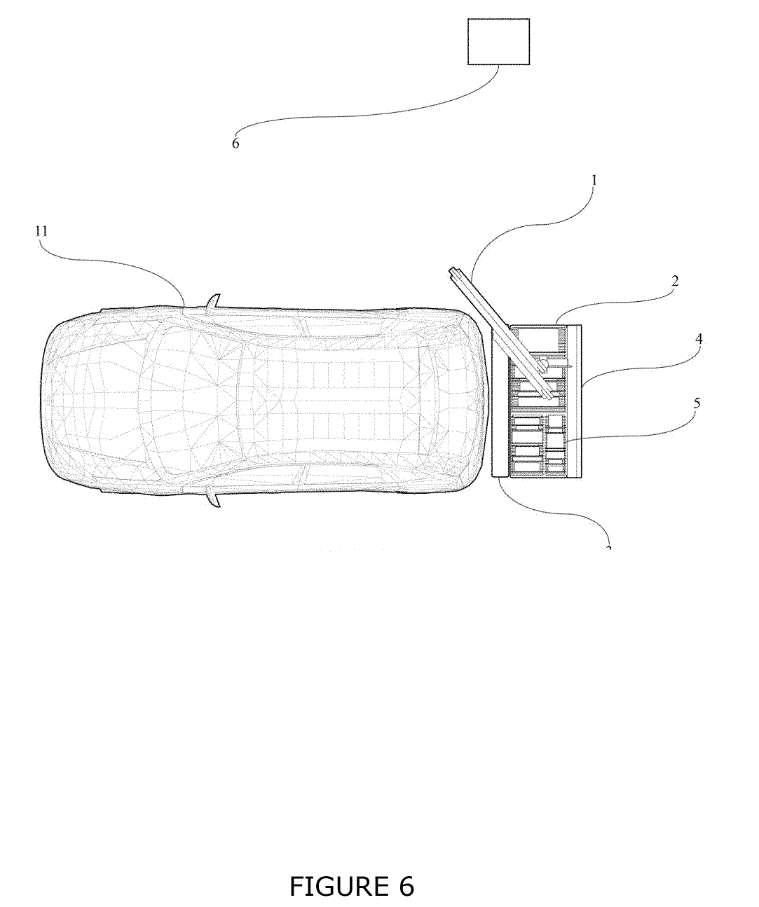

FIG. 7. illustrates the invention in perspective view in the process of connecting to an arm module.

FIG. 8. illustrates the invention in perspective view with the packages removed for clarity.

FIG. 9. illustrates the invention in rear view

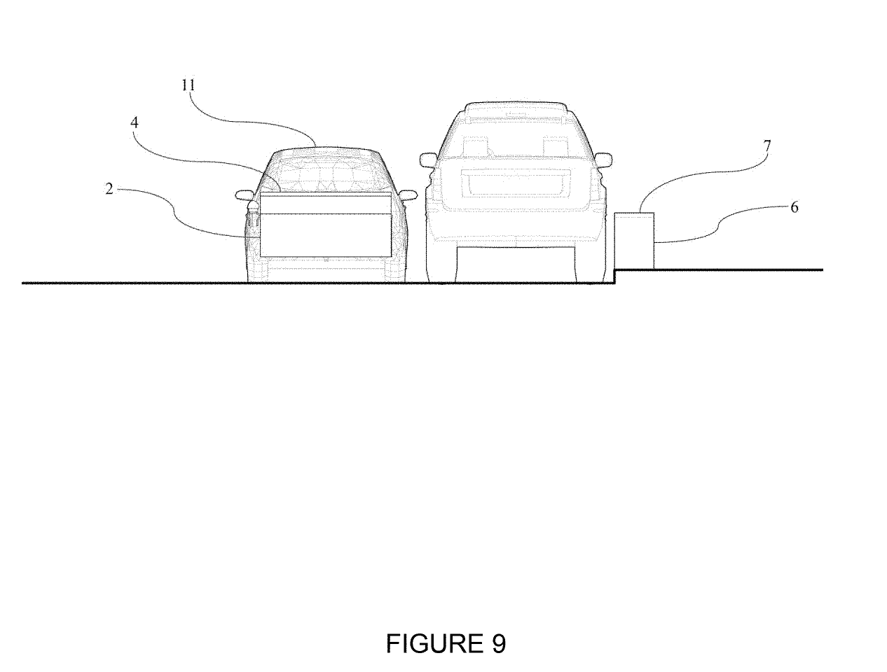

FIG. 10. illustrates the invention in perspective view

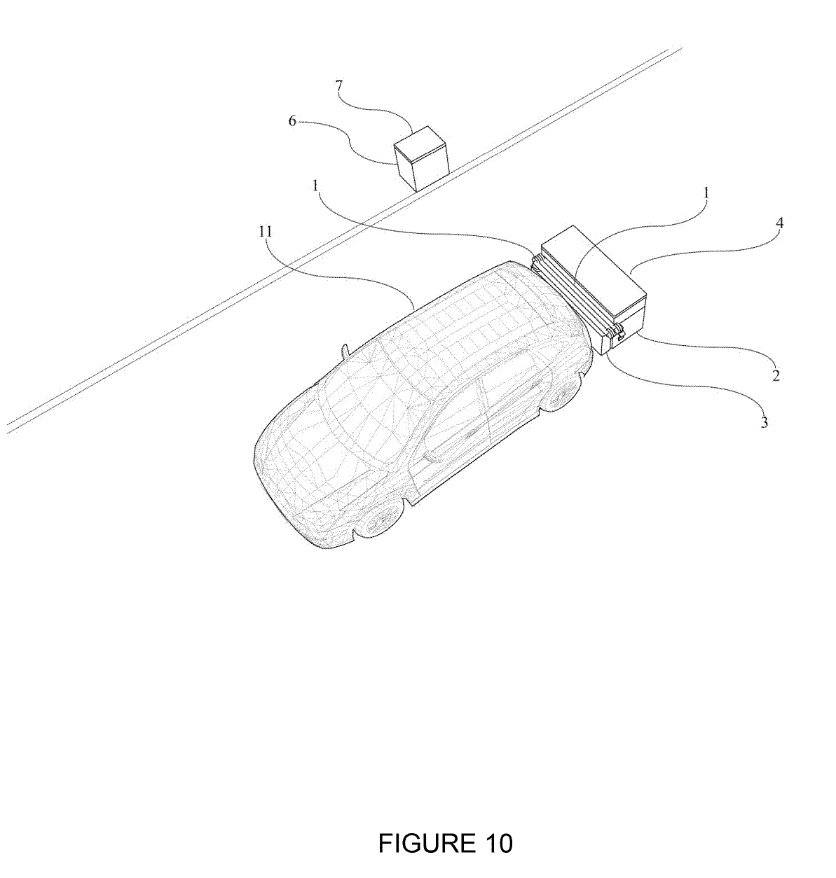

FIG. 11. Illustrates the package carrying enclosure in perspective view with the securable lid open and several packages removed for clarity.

FIG. 12. Illustrates a diagram of one possible method for delivery.

FIG. 13. Illustrates a diagram of one possible method for delivery.

### DETAILED DESCRIPTION OF INVENTION

Our invention contemplates the use of autonomous road vehicles coupled with a manipulator arm and package container to make deliveries of packages and other items to a plurality receptacles mounted at delivery locations.

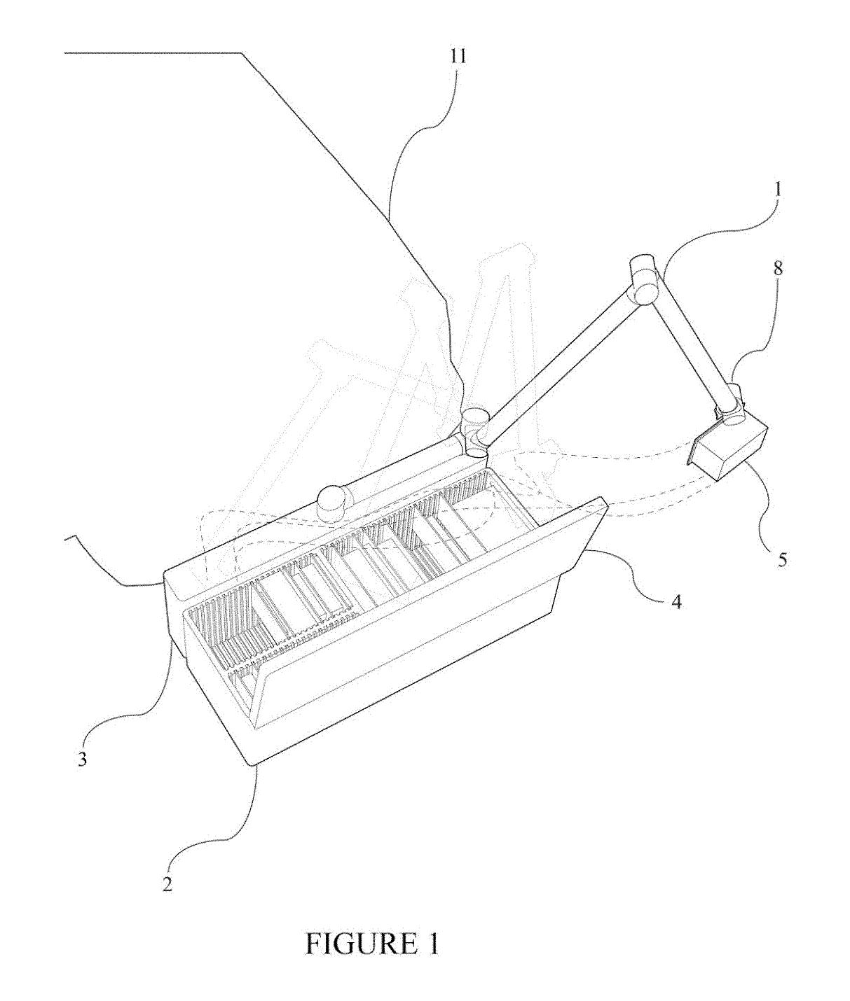

FIG. 1 shows a perspective view of one embodiment of my invention in the process of making a delivery. Vehicle 11 is coupled with arm module 3 and package carrying container 2. Arm 1 is extended. Hand 8 is grasping a package 5. Lid 4 is open to reveal the interior of container 2. A plurality of packages of different sizes are arranged in container 2 such that each one can be autonomously located and removed by arm 1.

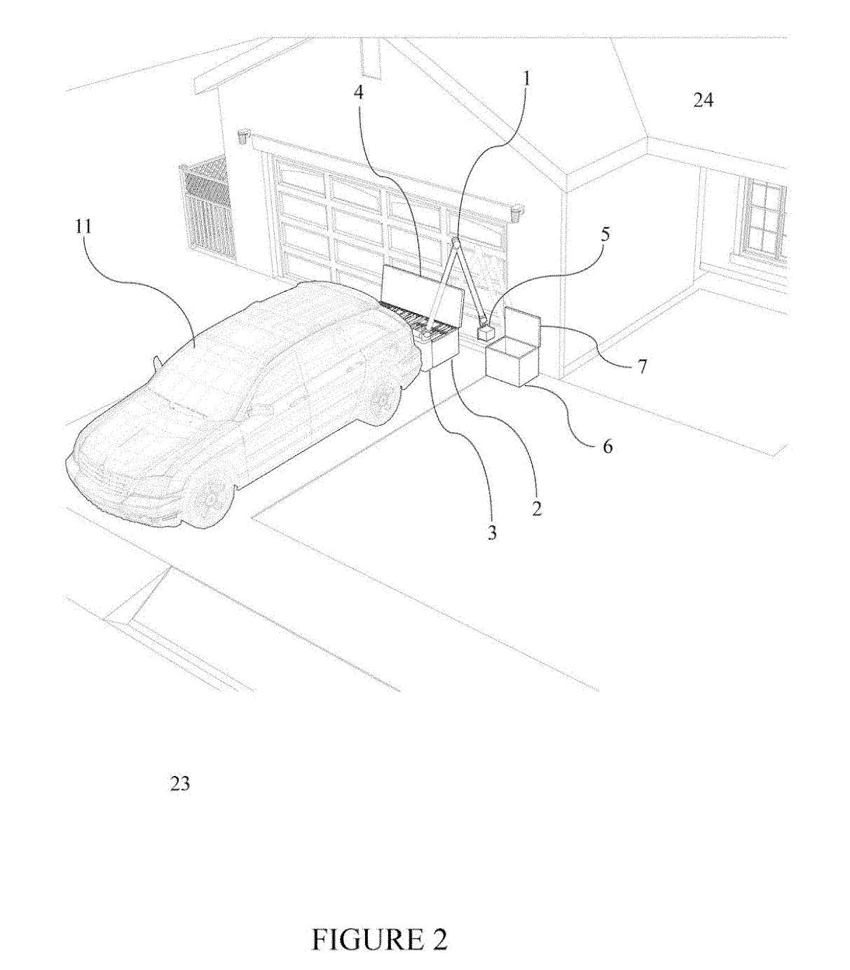

FIG. 2 shows a perspective view of one embodiment of my invention in the process of making a delivery to a detached dwelling typical of suburban areas. Vehicle 11 reaches the delivery location by roadway 23. Package receptacle is permanently mounted near the delivery location 24 such that it can be reached unassisted by vehicle 11. As vehicle 11 approaches package receptacle 6 a signal is sent to a electromechanical device contained in receptacle 6 and the lid is opened. The computer in module 3 begins a sequence of commands to manipulator arm 1 and container lid 4 to carry out a transfer of package 5 from container 2 to receptacle 6. These commands include but are not limited to, opening lid 4, extending arm 1, grasping the appropriate package in container 2 with hand 8, carrying package to receptacle 7 and releasing the package. Vehicle 11 is then directed by central computer network 19 to proceed to the next delivery location.

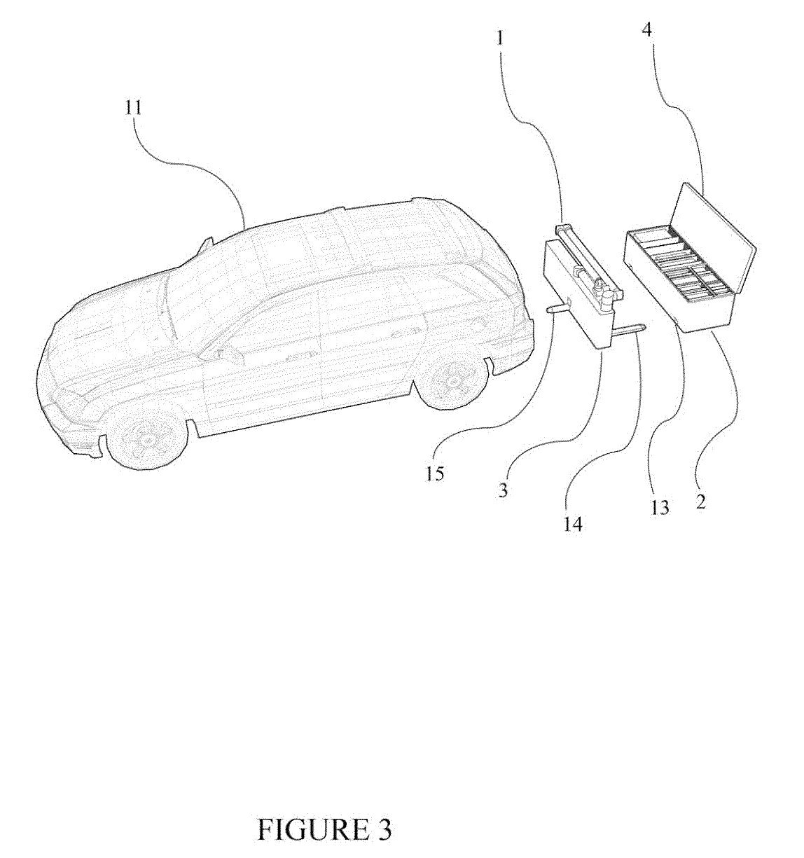

FIG. 3 shows a perspective view of one embodiment of my invention with the major components separated for clarity. Arm module 3 is connected to vehicle 11 by inserting tongue 15 into a socket at the rear of the vehicle. Forks 14 are connected to arm module 3. Package carrying enclosure 2 has sleeves that can be slid onto forks 14. Enclosure lid 4 is attached to package carrying container 2 with a hinged joint. Lid 4 is operative to open mechanically to allow access to packages in container 2. Manipulator arm 1 is attached to arm module 3 and operative insert and remove packages from package carrying container 2.

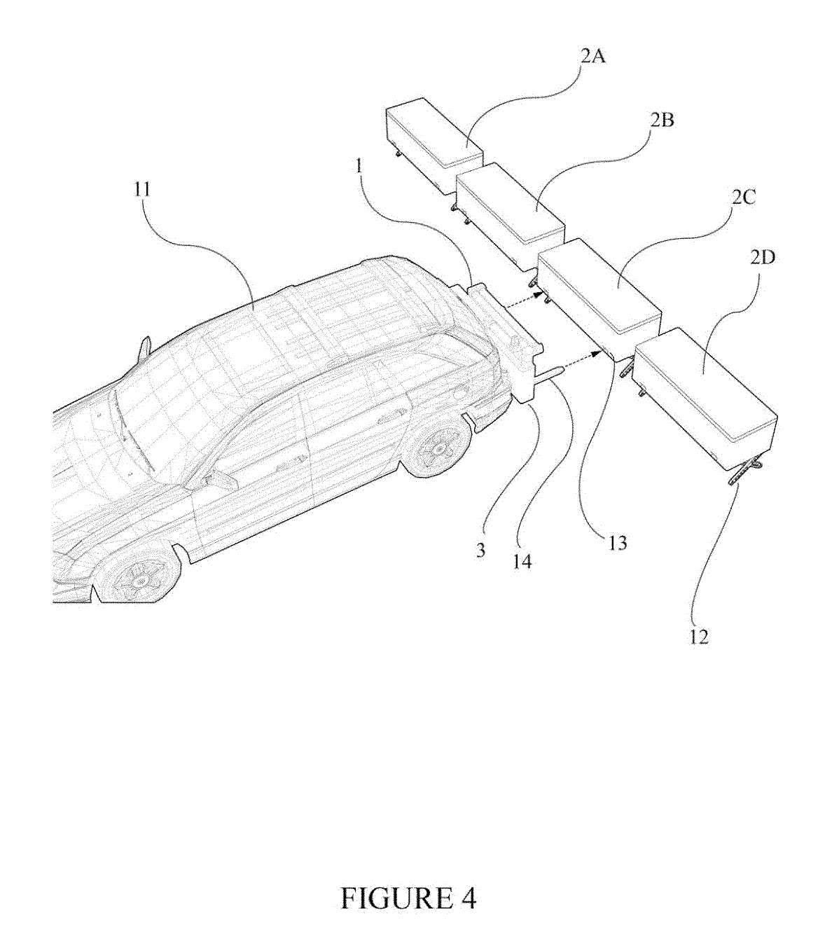

FIG. 4 shows a perspective view of one embodiment of my invention. More specifically, FIG. 4 shows a method of retrieving a container that has been loaded with goods to be delivered to a plurality of delivery location. Containers 2 have been loaded at a retail location or distribution center. Vehicle 11 is coupled with arm module 3. Forks 14 are extended and ready to be coupled with sleeves 13 in container 2c. Container legs 12 are extended to elevate containers 2 at the correct height to align sleeves 13 with forks 14. Vehicle 11 is guided autonomously by its internal systems rearward until container 2 is attached to module 3. Legs 12 are then retracted to achieve ground clearance. Vehicle 11 is then directed to proceed to the first delivery location.

Where the present supply chain sources inventory from distribution centers beyond the city center, the present invention could cultivate a more evenly dispersed distribution network. The role of brick and mortar stores could be augmented to act as distribution nodes serviced by delivery enabled self driving vehicles. These locations are already linked to a supply chain that brings bulk goods into population centers. Brick and mortar stores also have a labor force in place that could be tasked with loading containers for delivery.

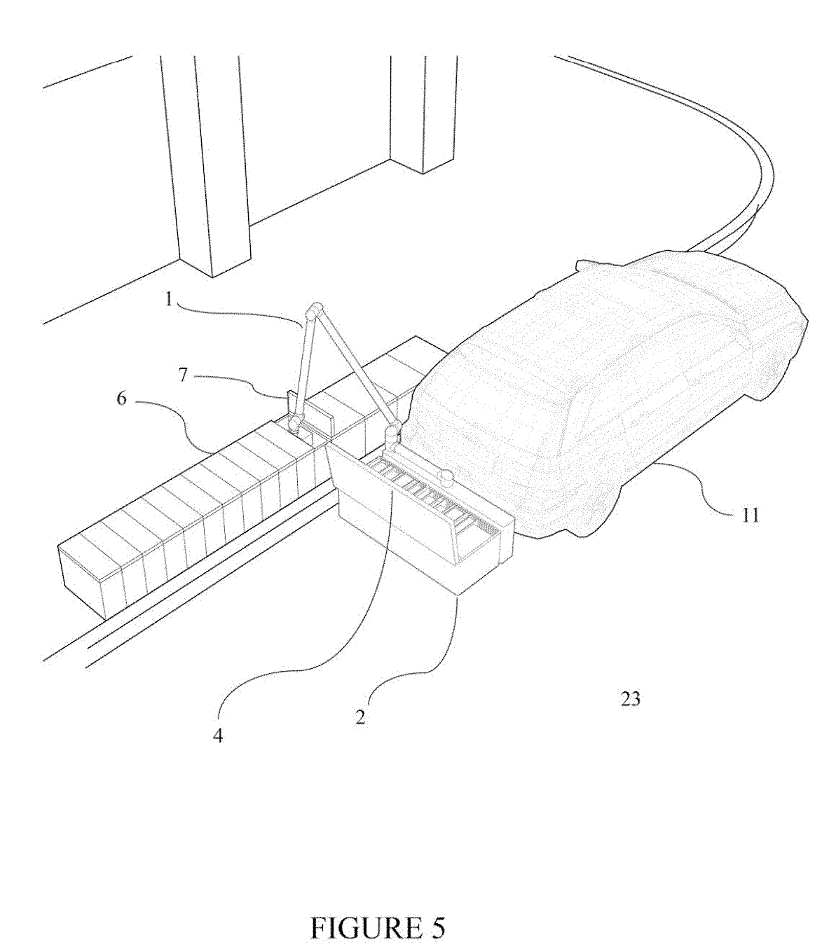

FIG. 5 shows a perspective view of one embodiment of my invention in the process of making a delivery to a cluster of mailboxes. This embodiment would be typical of urban areas where it is not practical or feasible to place a receptacle at each delivery address. Package receptacles 6 would be placed in groups of one or more in a location within convenient distance from a group of recipients. Once an order has been placed by one of these recipients, the appropriate package is delivered to any one of the receptacles at the location. The recipient is then sent a unique code allowing him or her access to the receptacle containing his or her package.

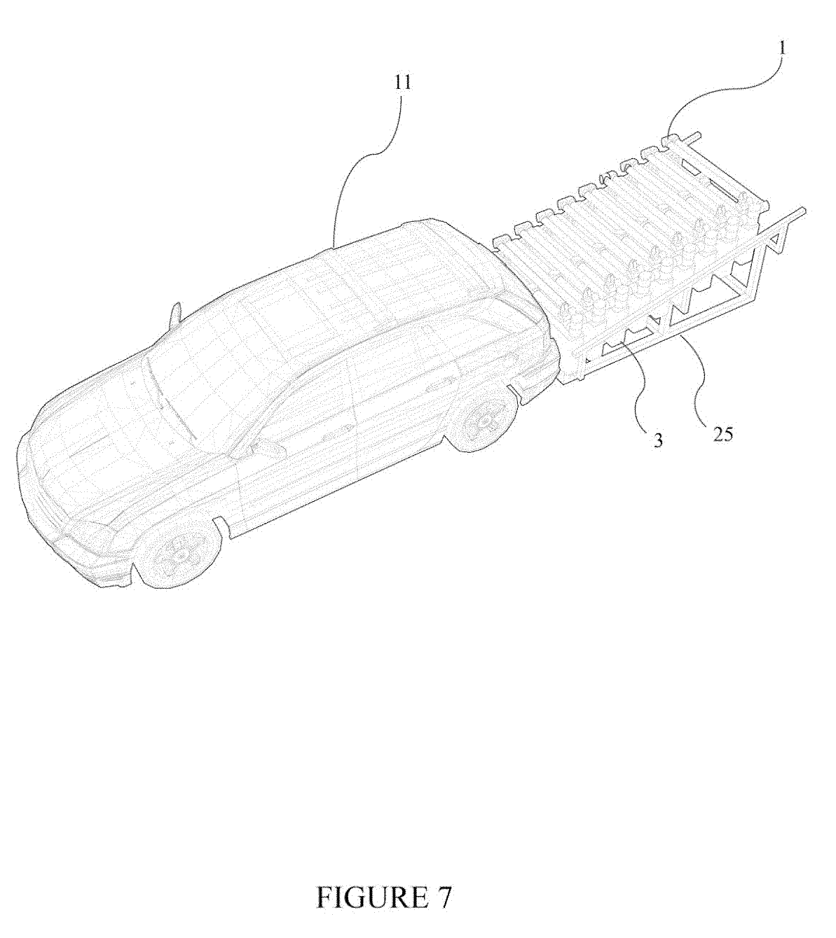

FIG. 7 shows a perspective view of one embodiment of my invention. More specifically, FIG. 7 shows a method of storing and retrieving arm modules 3 at locations dispersed throughout the location where the delivery system operates. While the vehicle is not in use as a delivery platform it could deposit arm module 3 autonomously on a stationary rack that is capable of holding one or more modules 3. The vehicle 11 retrieves an arm module 3 by backing up under the internal guidance of the vehicle's sensors and computer until the tongue 15 is coupled with a socket permanently attached to the rear of the car. Once the module 3 is attached a locking mechanism is engaged to prevent it from detaching. The vehicle 11 can then proceed to a location where loaded containers are staged as shown in FIG. 4. When one module 3 is removed the remaining modules 3 in the rack 25 move along rails either by gravity or mechanical means to fill the space left by the removed module.

The autonomous storage of arm modules allows a fleet of vehicles to respond to varying demand for passenger transport and supplement the revenue generated by passenger service. A given vehicle could divide its time between passenger service and package delivery without significant hardware investment. The only modification needed to enable package delivery would be the attachment of the socket at the rear of the vehicle to accept tongue 15.

The ability of a vehicle fleet to switch between passenger service and package delivery also has the added benefit of decreasing the overall number of vehicles required to accomplish the two tasks combined. This smaller fleet would minimize fixed costs associated with the operation, maintenance and storage of a fleet. Also, by allowing the fleet to share a smaller number of arm modules rather than have a dedicated arm on each vehicle, the capital costs associated with deploying delivery hardware would be minimized.

Additionally, since the dual purpose passenger/package fleet would naturally shift from one task to the other with changes in demand, it would have the benefit of ameliorating traffic congestion. Delivery tasks would tend to be carried out at times when passenger demand was lower and not during rush hour times. Packages with a lower priority could be delivered at night or early morning when congestion is low. This would make delivery faster and correspondingly less expensive. A delivery enabled fleet using the streets during the night could travel much faster and thus make more deliveries.

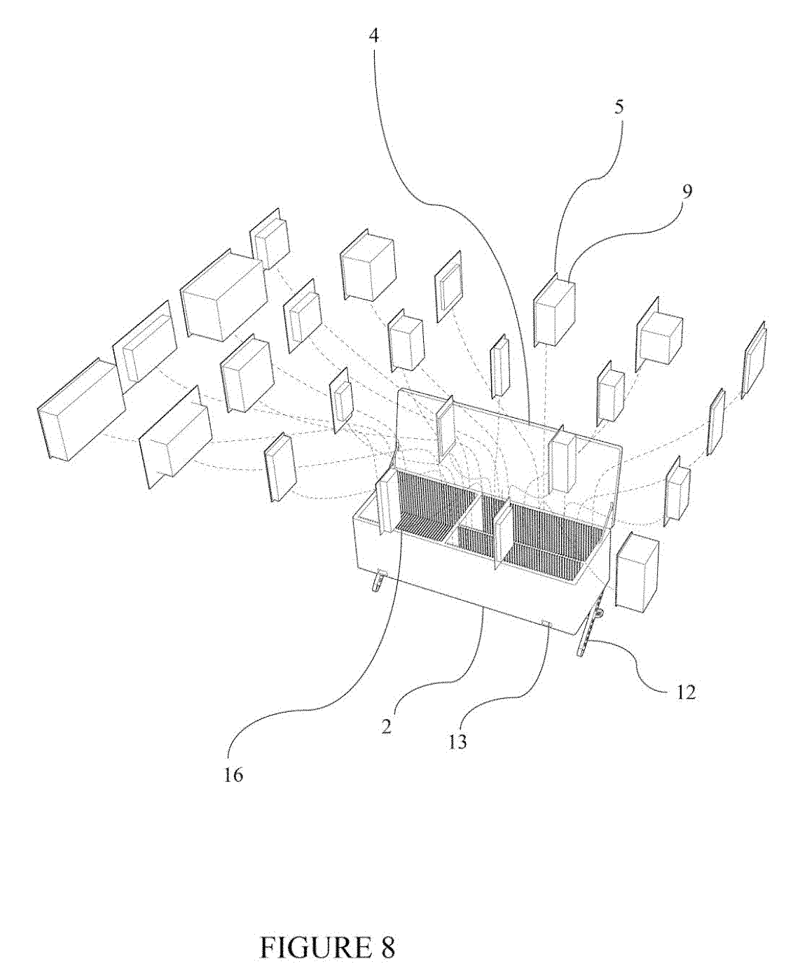

FIG. 8 shows a perspective view of one embodiment of my invention. The package carrying container 2 is shown resting on the extended legs 12. The lid 4 is shown in the open position. A number of packages representing a range of sizes is shown removed from the container for clarity. Packages 9 are shown mounted to flanges or panels 5. This figure illustrates the ability of the container to accommodate packages with a wide range of sizes while using the given volume of the container efficiently.

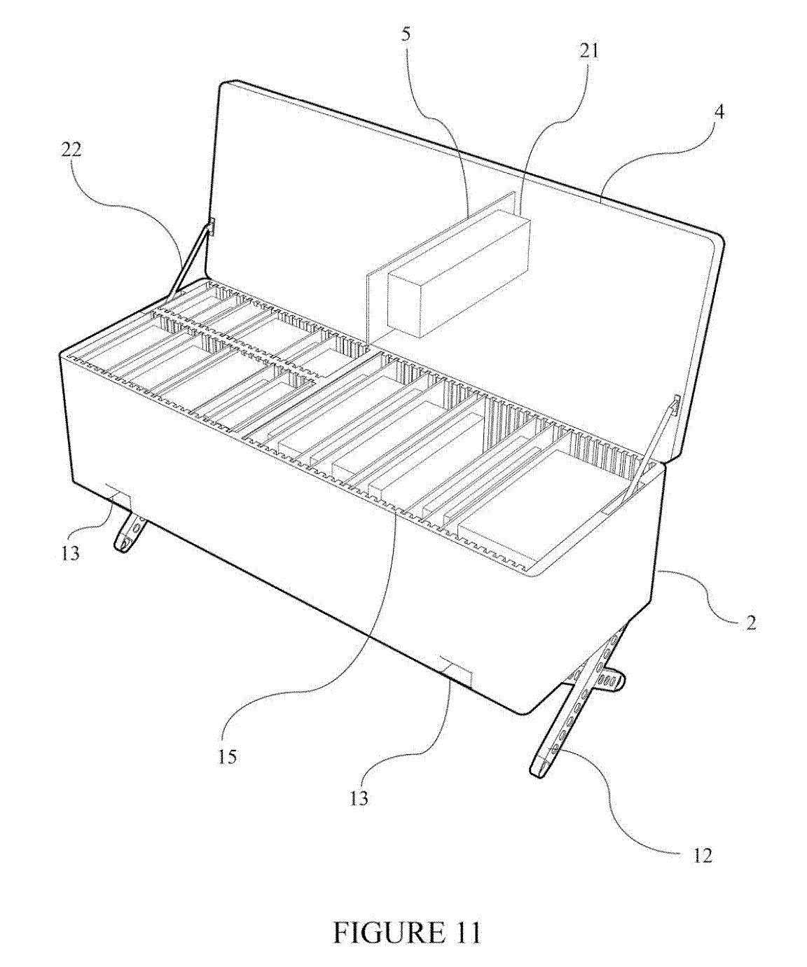

FIG. 11 shows of view of the package carrying enclosure with some of the packages removed for clarity. The enclosure 2 is subdivided into 1 or more compartments of different widths to accommodate packages of different sizes. Said compartments are fitted with grooves 15 on the interior. Panels 5 are inserted into grooves 14. Panels are sized such that their width is equal to the distance between the grooves of a given compartment. Compartments are sized to accommodate a range of typically sized packages.

Retractable legs 12 are operative to extend and retract mechanically to support package carrying enclosure 2 at an appropriate height to be coupled with arm module 3.

Referring again to FIG. 11, panel 5 could be fitted with an optical tag that would allow identification by an optical scanner mounted to grasping hand 8. This tag would be assigned delivery information that would include destination, weight, size and other necessary metrics.

As shown in figures the autonomous road vehicle could be a small passenger vehicle modified to carry an arm module 3 and enclosure module 2. The vehicle could be equipped with a socket to accept the tongue 15. In another embodiment of the invention a larger self driving truck could be used in place of the passenger vehicle.

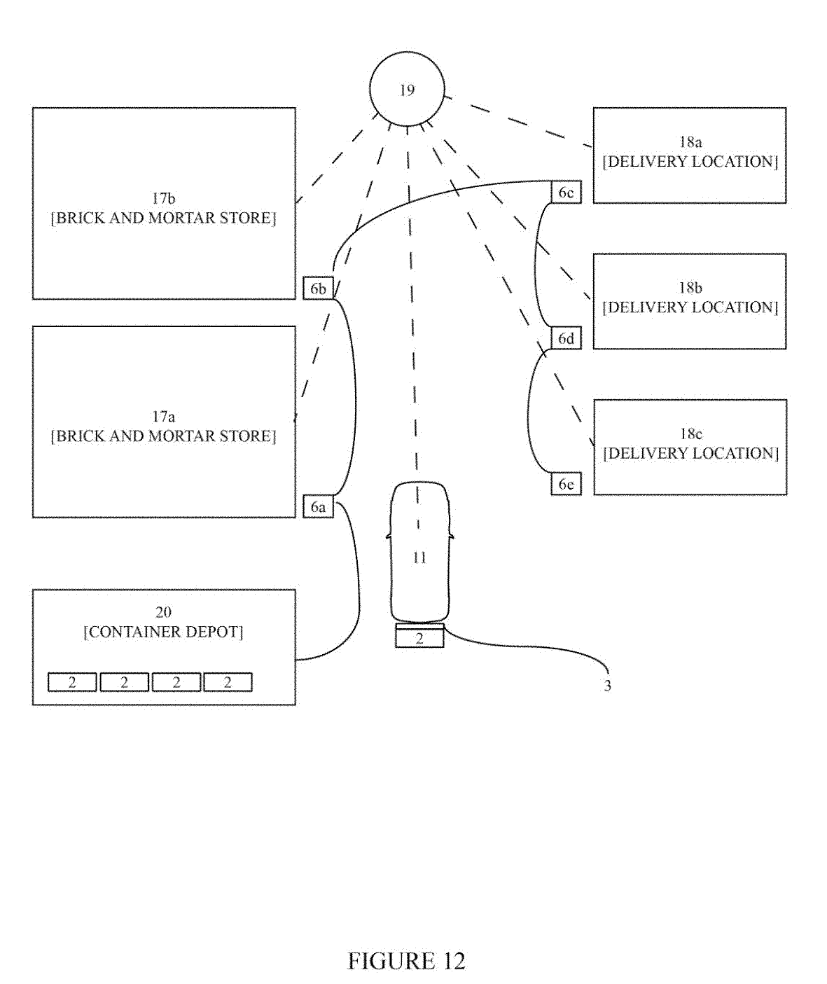

FIG. 12 shows one embodiment of a delivery network. An autonomous vehicle, 11 receives a wireless command from a computer control system 19 to proceed to a container depot 20 where empty containers 2 are stored. This depot could be a local warehouse or fenced in area with controlled access. The depot could also be used to store arm modules, 3. Said self driving car would autonomously pick up an empty container, 2 and arm module, 3. The self driving vehicle would then proceed to a brick and mortar store, 17. Said brick and mortar store would have an enclosure 6a located near the roadway where it could be accessed by said self driving vehicle 11. Said container 6a would be loaded with parcels to be delivered. The self driving vehicle would drive to the brick and mortar store 17a where the arm 1 would retrieve the parcels to be delivered. Said self driving vehicle could make stops at a plurality of pick up locations until its container reached capacity. Said self driving vehicle could then proceed to delivery locations 18 to deliver the packages. Pickup and delivery would be coordinated by a computer control system 19 to optimise for travel distance and delivery time.

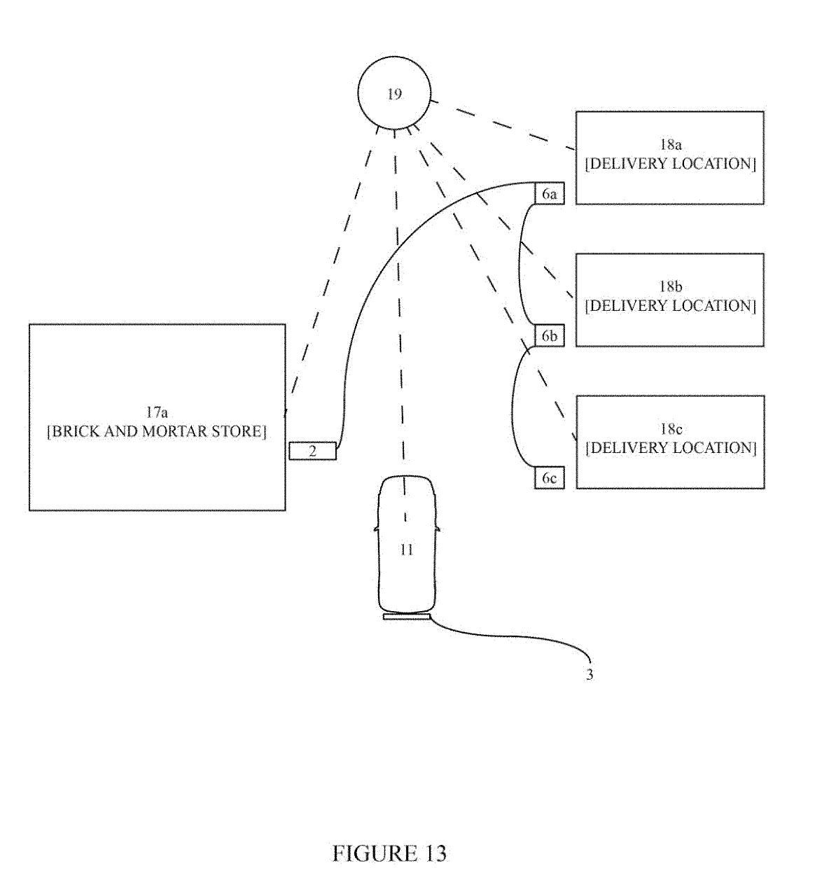

FIG. 13 shows another embodiment of a delivery network. A self driving car 11, equipped with an arm module 3, would be directed by a computer control system 19 to travel to a store, 17a. A container module 2 would be loaded with goods 14 and would be placed near the roadway. The self driving car would pick up the waiting container 2 and proceed to delivery locations 18 where it would deposit the goods in a drop off container 6. After all of the goods were delivered the vehicle would return to the store and drop off the empty container to be refilled.

### SUMMARY OF THE INVENTION

In one embodiment of the invention a package delivery platform which attaches to an autonomous vehicle is provided, comprising a module containing controls and a manipulator arm with a hand capable of grasping a package and placing it in an enclosure at a delivery location, a detachable enclosure with a securable lid in which packages are carried, and a securable enclosure placed permanently at a plurality of delivery locations.

Also in one embodiment the packages are carried in an enclosure with a securable self opening lid. Also in one embodiment retractable legs are provided to allow the enclosure to stand at an appropriate level to be autonomously retrieved at a location without assistance. Also in one embodiment a mechanism is provided to allow autonomous attachment to the enclosure. Also in one embodiment the manipulator arm can be fitted with attachments that allow it to perform maintenance tasks along the roadway. Also in one embodiment a mechanism is provided to allow autonomous attachment to the module.

Also in one embodiment, a mechanism is provided to allow autonomous attachment a to a self driving vehicle. Also in one embodiment a computer contained within the module is programmed to, a. communicate with a central network to receive delivery location information and optimize delivery routing, and b. control a manipulator arm to retrieve packages from the enclosure of claim 1 and deposit them at the delivery location. Also in one embodiment a securable lid is mechanically opened when it receives a radio or infrared signal from the approaching delivery vehicle. Also in one embodiment, the interior of the enclosure is fitted with grooves to store packages such that they can be retrieved by a robotic arm and transported to another delivery location. Also in one embodiment, one or more enclosures are mounted at a public location and shared by a group of users. Also in one embodiment, an individual recipient is given temporary access to the enclosure either by alpha-numeric pin to be entered manually by keypad or by electronic code sent to a device carried by the recipient.

In another aspect of the invention, a method for arranging packages in an enclosure is provided wherein they can be retrieved by a manipulator arm. In one embodiment of the method, items to be shipped are placed in a disposable carton or reuseable container fitted with flanges or flat panels sized to fit in corresponding slots in the enclosure. Also in one embodiment of the method, an enclosure is divided into compartments of varying widths to accommodate packages of different sizes. In another embodiment of the method, a manipulator arm is fitted with a hand capable of grasping the flat panels to which the packages are mounted.

### PATENT CITATIONS

| Cited Patent | Filing date | Applicant | Title |
|---|---|---|---|
| US 20150006005 A1 | Jun. 29, | Steven Sounyoung Yu, Sounil Yu | Autonomous Unmanned Road Vehicle for Making |
| | 2014 | | Deliveries |
| U.S. Pat. No. 9,256,852 B1 | Jul. 1, 2013 | Jussi Myllymaki | Autonomous delivery platform |
| US20130240673 A1 | Sep. 19, | Kevin Schlosser, | Enabling multiple autonomous cargo deliveries in a |
| | 2013 | | single mission |
| US20140032034 A1 | Jan. 30, | Andreas Raptopoulos, Darlene | Transportation using network of unmanned aerial |
| | 2014 | Damm | vehicles |
| US20160026967 A1 | Jan. 28, | Jitendra Shah, Christian Ress, | Method for assisting in collection of goods by a vehicle |
| | 2016 | Stefan Wolter | |
| U.S. Pat. No. 9,070,101 B2 | Jun. 30, | Raj Abhyanker | Peer-to-peer neighborhood delivery multi-copter and |
| | 2015 | | method |
| WO2014080390 A2 | May 30, | Wasfi Alshdaifat, Eida | Autonomous conveyor interfacing aerial delivery |
| | 2014 | Almuhairbi, Farah Afif | |
| US20140136414 A1 | May 15, | Raj Abhyanker | Autonomous neighborhood vehicle commerce network |
| | 2014 | | and community |
| U.S. Pat. No. 9,026,301 B2 | May 5, | Aldo Zini, Spencer Wayne | Robotic ordering and delivery system software and |
| | 2015 | ALLEN, Barry Mark Skirble, | methods |
| | | Henry F. Thome, Stuart Fairley | |
| US20150153175 A1 | Jun. 4, 2015 | Ole-Petter Skaaksrud | Autonomous transport navigation to a shipping location |
| | | | using elements of a wireles node network |
| U.S. Pat. No. 8,010,230 B2 | Aug. 30, | Aldo Zini, Spencer Wayne | Robotic ordering and delivery apparatuses, systems |
| | 2011 | ALLEN, Barry Mark Skirble, | and methods |
| | | Henry F Thome, Stuart Fairley | |
| WO2015061008 | Apr. 30, | Gur Kimchi | Unmanned aerial vehicle delivery system |
| A1 | 2015 | | |
| US20080109246 | May 8, | Mark C. Russell | Method for Cooperative transport of parcels |
| A1 | 2008 | | |
| WO2016012742 | Jan. 28, | Andrew David Whiteside | Same-day order fulfilment and delivery means and |
| A1 | 2016 | | apparatus therefor |
| US20040193314 | Sep. 30, | David Tilles, David Janos, Mark | Item delivery and retrieval system |
| A1 | 2004 | Neebe, Bruce Chestnutt, Ann | |
| | | Schofield, Randall Neilson | |
| U.S. Pat. No. 6,057,779 A | May 2, | Benjamin G. Bates | Method of controlling access to a movable container |
| | 2000 | | and to a compartment of a vehicle, and a secure cargo |
| | | | transportation system |
| US20080319574 | Dec. 25, | Wolf-Stephan Wilke | Method and device for transporting objects to |
| A1 | 2008 | | distribution points |
| WO2014022523 | Feb. 6, 2014 | Stephen H. Hancock, Norman | Package delivery kiosk including integrated robotic |
| A1 | | B. Desrosiers, Eric FIEST, | package lifting assembly with shelving system |
| | | John Rupert | |
| US20120006651 | Jan. 12, | Kevin Cote | Robotic row collector |
| A1 | 2012 | | |
| U.S. Pat. No. 6,866,471 B2 | Mar 15, | Robert S. Grams, Thomas | Method of using a robotic containerization and |
| | 2005 | Watson, Patrick Resch, Gilbert | palletizing system |
| | | Dominguez | |
| WO2015035300 | Mar. 12, | Michael S. KHODL, David M. | Autonomous mobile picking |
| A1 | 2015 | Berghom, Todd S. HUNTER | |
| U.S. Pat. No. 7,138,596B2 | | | Apparatus and method for mail sorting |
| U.S. Pat. No. 5,893,697A | | | Automated system for selecting packages |
| | | | from a storage area |
| US20020147919A1 | | Daniel Gentry | Secured delivery system for unattended |
| | | | receiving and shipping of parcels and letters |
| WO1996003259A1 | | | Self-contained mobile unit with space-saving |
| | | | manipulator and appropriate control process |
| US20140081445 A1 | | | Automated delivery vehicle, systems and |
| | | | methods for automated delivery |
| US | | | |
| 20150379468 A1 | | | |

### PATENT CLASSIFICATIONS

B65G1/0435

Storage devices mechanical using stacker cranes with pulling or pushing means on either stacking crane or stacking area

G06Q10/08

Logistics, e.g. warehousing, loading, distribution or shipping; Inventory or stock management, e.g. order filling, procurement or balancing against orders

G05D 1/02

Control of position or course in two dimensions

1: A package delivery platform which attaches to an autonomous vehicle comprising:
a. A module containing controls and a manipulator arm with a hand capable of grasping a package and placing it in an enclosure at a delivery location.
b. A detachable container with a securable lid in which packages are carried.
c. A receptacle with an automated, securable lid which mounts near the roadway at a delivery location for receiving packages.

2: Platform of claim 1 wherein packages are carried in an container with a securable self opening lid.

3: The container of claim 1 wherein retractable legs are provided to allow the enclosure to stand at an appropriate level to be autonomously retrieved at a location without assistance.

4: The module of claim 1 wherein a mechanism is provided to allow autonomous attachment to the container of claim 1.

5: The module of claim 1 wherein a mechanism is provided to allow autonomous attachment a to a self driving vehicle.

6: The module of claim 1 wherein a computer contained within the module is programmed to:
a. communicate with a central network to receive delivery location information and optimize delivery routing.
b. control a manipulator arm to retrieve packages from the container of claim 1 and deposit them at the delivery location.

7: Receptacle of claim 1 wherein a securable lid is mechanically opened when it receives a radio or infrared signal from the approaching delivery vehicle.

8: Receptacle of claim 1 wherein the interior of the enclosure is fitted with grooves to store packages such that they can be retrieved by a robotic arm and transported to another delivery location.

9: The receptacle of claim 1 wherein one or more receptacles are mounted at a public location and shared by a group of users.

10: receptacle of claim 1 wherein an individual recipient is given temporary access to the enclosure either by alpha-numeric pin to be entered manually by keypad or by electronic code sent to a device carried by the recipient.

11: Method for arranging packages in a container so that they can be retrieved by a manipulator arm.

12: Method of claim 11 wherein items are placed in a disposable carton or reuseable container fitted with flanges or flat panels sized to fit in corresponding slots in the container of claim 1.

13: Method of claim 11 wherein container is divided into compartments of varying widths to accommodate packages of different sizes.

14: Method of claim 11 wherein a manipulator arm is fitted with a hand capable of grasping the flat panels to which the packages are mounted.

15: Method of claim 11 wherein reusable containers are identified with an optical or magnetic tag that can be assigned to a unique delivery location.

16: Method of claim 11 wherein tag of claim 15 can be read by an optical or magnetic scanner attached to the grasping hand of claim 1.

17: A method of delivering packages comprising the steps of:
a. Directing a self driving vehicle to a location where arm modules of claim 1 are stored and attaching them autonomously to the vehicle.
b. Directing the vehicle with attached arm module to a location where package carrying containers have been pre-loaded with goods for delivery.
c. Autonomously connecting a loaded container to the vehicle.
d. Directing the vehicle with loaded container to a plurality of delivery locations.
